(19) United States
(12) Patent Application Publication
(10) Pub. No.: US 2026/0023405 A1
(43) Pub. Date: Jan. 22, 2026

(54) SELF STARTUP BANDGAP CIRCUIT

(71) Applicant: Altera Corporation, San Jose, CA (US)

(72) Inventors: Ahmad Samhan MOHAMED ASLAM, Kuala Lumpur (MY); Aditya KELKAR, Round Rock, TX (US); Maneesha YELLEPEDDI, Los Gatos, CA (US); Ping XIAO, E Palo Alto, CA (US)

(21) Appl. No.: 19/340,707

(22) Filed: Sep. 25, 2025

(51) Int. Cl. G05F 3/26

(52) U.S. Cl. CPC G05F 3/262

(57) ABSTRACT

In some examples, a self-starting bandgap circuit is provided. It may include one or more chopping circuits to reduce pre-trim inaccuracies. It may also, or alternatively, include an adaptive bandgap supply regulator and/or a start-up comparator to speed up the bandgap circuit's ability to come up with an adequate bandgap reference voltage.

### TECHNICAL FIELD

Embodiments relate to the field of semiconductor devices and in particular to integrated circuit bandgap reference circuits.

### BRIEF DESCRIPTION OF THE DRAWINGS

The disclosure may best be understood by referring to the following description and accompanying drawings that are used to illustrate embodiments. In the drawings:

FIG. 1 is a general diagram showing a bandgap reference circuit for a power on reset scheme in accordance with some embodiments.

FIG. 2 is a signal diagram illustrating a timing requirement for the bandgap Vref signal in accordance with some embodiments.

FIG. 3 is a diagram showing an exemplary power-on-reset (POR) detection system for an IC with 3 power supplies in accordance with some embodiments.

FIG. 4A is a signal diagram illustrating a power-up sequence for the example POR detection system of FIG. 3 in accordance with some embodiments.

FIG. 4B is a signal diagram showing another power-up configuration in accordance with some embodiments.

FIG. 5 is a circuit diagram showing a fast start-up bandgap reference circuit in accordance with some embodiments.

FIG. 6 illustrates an example computing system including a bandgap circuit in accordance with some embodiments.

FIG. 7 illustrates a block diagram of an example processor that may have one or more cores and an integrated memory controller in accordance with some embodiments.

FIG. 8 is a block diagram illustrating a parallel processing computing system configured to implement one or more aspects of the examples described herein.

### DETAILED DESCRIPTION

In analog and mixed signal integrated circuit (IC) designs, bandgap circuits are typically used to generate process-voltage-temperature (PVT) independent voltage reference (Vref) voltages for a variety of different circuit blocks such as analog to digital converters (ADCs), phase locked loops (PLLs), voltage regulators, and the like. To achieve required accuracy, they are often fuse-trimmed to improve reference level precision, compensating for manufacturing variations from device mismatches. Usually in a voltage reference application, the reference voltage is used after the IC has powered up and the bandgap circuit has been trimmed, so typical bandgap start-up is usually not a serious challenge.

However, with some IC applications such as with FPGA (field programmable gate array) devices, such bandgap circuits that start slowly and/or require post start-up trimming may not be suitable. For example, in some applications, bandgap based power on reset (POR) may be employed where a bandgap circuit should be able to start-up quickly and provide a reasonably accurate output reference voltage. Accordingly, in some embodiments, self starting bandgap circuits, suitable for power-on-reset, as well as for other applications, may be provided.

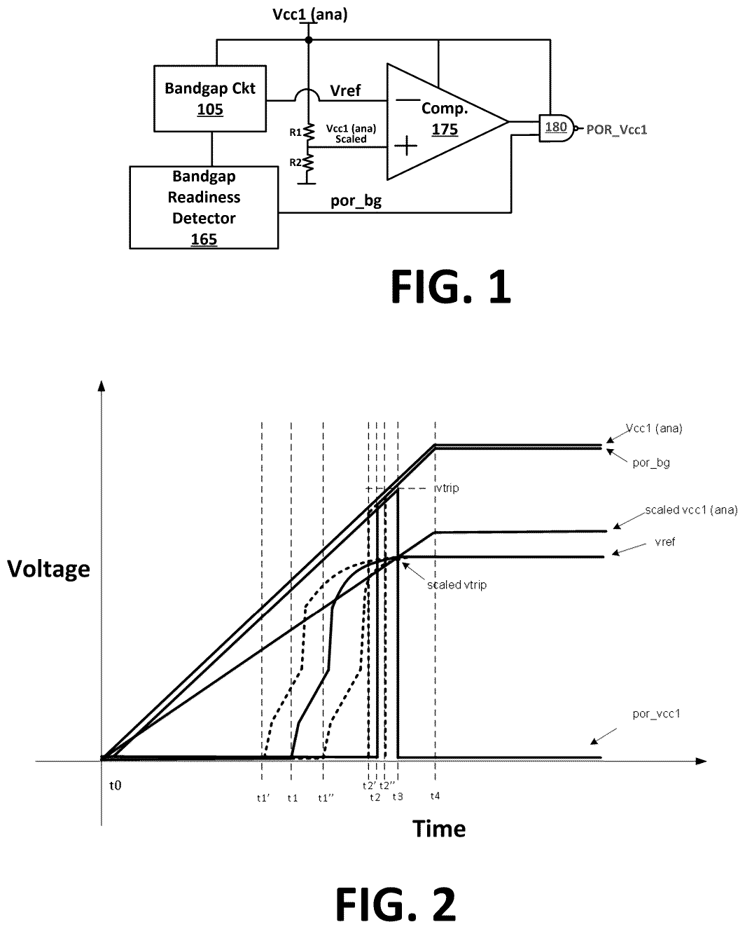

FIG. 1 is a general diagram showing a bandgap reference circuit for a power on reset scheme in accordance with some embodiments. The POR circuit includes a bandgap reference circuit 105 and a bandgap readiness detector 165 coupled to a power on comparator 175 as is indicated. All the bandgap circuit, bandgap readiness detector and comparator are powered by a voltage supply (Vcc1), which in this example, is an analog supply, e.g., around 1.2 V.

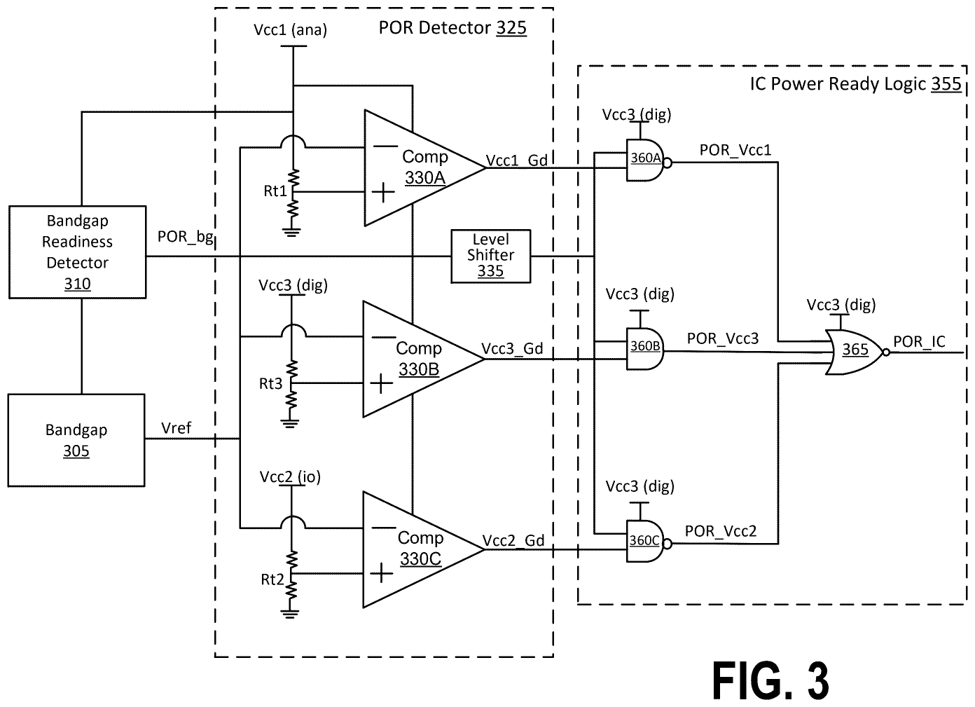

As the Vcc1 supply comes up, it not only powers up the bandgap circuit, the bandgap readiness detector and the comparator, but it also sets a scaled threshold level for the comparator using the resistor ladder formed from R1 and R2. The reference (Vref) generated by the bandgap circuit 105 off of the Vcc1 supply, itself, is then used as the comparator's reference to detect when the supply (Vcc1) has powered up to an acceptable level. The bandgap readiness detector tracks the bandgap operation during the supply (Vcc1) is powered up and generates the por_bg signal to indicate when the bandgap output Vref is stable and ready to use. It gates the comparator output to generate power good signal POR_Vcc1. For various different reasons, the Vref value should be reasonably accurate so that the power good signal (POR_Vcc1) doesn't assert too late or too early. This timing challenge is illustrated in the diagram of FIG. 2.

FIG. 2 is a signal diagram illustrating a timing requirement for the bandgap Vref signal in accordance with some embodiments. The bandgap circuit generates Vref, using as its supply, the Vcc1 supply voltage. The diagram shows the nominal Vref signal, along with its fast and slow corner version limits. The diagram also shows the nominal por_bg signal, corresponding to the tracking of the bandgap output Vref at its fast and slow corners. The analog comparator (e.g., 175) compares the Vref signal with a scaled version of Vcc1 and its output is then gated by the signal por_bg that is generated from the bandgap readiness detector 165 to ensure the final POR signal (POR_Vcc1) trips (asserts low) when the Vcc1 supply ramps up to the trip level. The accuracy of Vref, as well as whether it comes up in time, determines the accuracy of the power good detection.

As shown in the figure, the Vcc1 supply ramps up from time t0 to t4. The bandgap Vref starts up at t1 (which can vary between t1′ to t1″ over PVT) to t3 where it becomes stable at its designed output level (e.g., 0.8 V). The bandgap readiness detector generates a corresponding tracking signal por_bg to indicate when the Vref is stable and ready to use at t2 (which can vary between t2′ to t2″ over PVT). To ensure the comparator generates a solid trip for the POR_Vcc1 detection, the scaled Vcc1 signal should be able to cross the slowest bandgap Vref level starting at t1″. To achieve a desired trip level accuracy, the pre-trimmed bandgap Vref should also be able to meet the desired accuracy. It should be at its designed-for stable level by or before time t3 so that when POR_Vcc1 asserts, it may reliably be assumed that the Vcc1 supply is, in fact, available and valid.

Accordingly, for IC POR detection, as well as for other applications, it would be desirable to have a bandgap circuit with fast activation upon power-up. It would also be desirable to have a bandgap circuit with low pre-trim variation to be able to meet detection accuracy objectives upon power-up prior to trim adjustments being available.

In some embodiments, these and/or other objectives may be attained with some or all of the following features. In some embodiments, chopping techniques may be employed with amplifiers and/or PTAT/CTAT (proportional to absolute temperature/complementary to absolute temperature) diode current paths to reduce device mismatch.

In some embodiments, dynamic element matching (DEM) techniques on current mirror transistors of the bandgap output stage may also, or alternatively, be used to reduce transistor variations to achieve reduced pre-trim variation. In some embodiments, the chopping may be based on a free-running oscillator with high resistance/capacitance characteristics to reduce supply sensitivity and effectively start-up off of a ramping supply. In some embodiments, a bandgap circuit may also, or otherwise, include an AVR (Adaptive Voltage Regulator), which may include an adaptive reference comparator (ARC), which in cooperation with a linear regulator such as an LDO (low drop-out) regulator or suitable operational amplifier configuration, may provide initially higher bandgap supply voltage during supply ramping to cause the bandgap circuit to turn on more quickly. With some or all of these features, a bandgap circuit may be able to deliver fast startup upon power-on and/or may provide a reference voltage with low pre-trim output variation that enables an IC to reliably come up using a power-on reset (POR) scheme, for example, without the need for an independent power delivery power good detection feature.

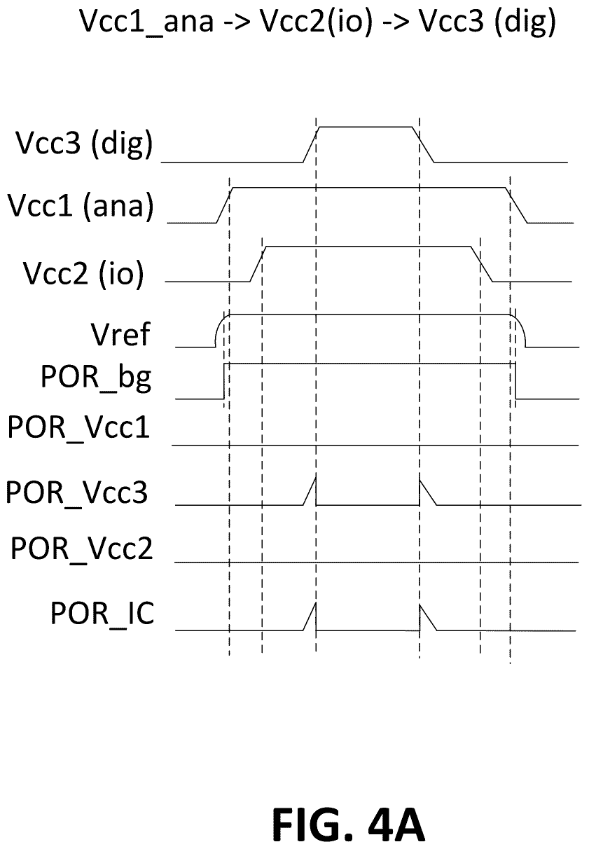

FIG. 3 is a diagram showing an exemplary power-on-reset (POR) detection system for an IC with 3 power supplies in accordance with some embodiments. With this example, the IC has at least three supplies: Vcc1 (an analog supply), vcc2 (an input/output supply), and Vcc3 (a supply for digital circuitry). For example, the analog supply (Vcc1) may be around 1.2 V, the IO supply (Vcc2) may be around 1.8 V, and the digital supply (Vcc3) may be around 0.75 V. with this POR detection system, a final POR signal POR_IC asserts (active high) and releases the IC when the three supplies are good.

The depicted POR detection system includes a fast-starting bandgap (or simply bandgap) circuit 305, a bandgap readiness detector circuit 310, a POR detector circuit 325, and an IC power ready logic circuit 355, all coupled together as shown.

The bandgap circuit 305 is implemented in accordance with embodiments disclosed herein. With this example, it, along with the bandgap readiness detector 310 and POR detector circuit 325, are powered by the Vcc1 (analog) supply. However, any other suitable IC supply (e.g., Vcc2, Vcc3) could be used.

The bandgap circuit 305 generates a Vref voltage reference signal for the POR detector circuit 325 and the IC power ready logic 355. In another example, the bandgap circuit 305 includes an adaptive voltage Regulator (not shown) to generate a regulated internal bandgap supply (Vcc_bg) to power the bandgap circuit 305 and the bandgap readiness detector 310 and to enable fast bandgap startup. The Bandgap readiness detector 310 generates a POR_bg (active high) signal to indicate to the POR detector 325 that the Vref signal is available once it is stable.

The POR detector 325 includes a group of analog comparators (330A, 330B, 330C), one for the detection of each power supply. The comparators are powered from the Vcc1 supply. They each include a first input that is coupled to the Vref signal from the bandgap circuit and a second input that is coupled to the output of an associated scaling resistor ladder (Rt1, Rt2, or Rt3) corresponding to the particular supply that it is to detect. The POR detector 325 also includes a down level shifter circuit 335 to provide to the IC power ready logic 355 a downward shifted version of the POR_bg signal, which indicates whether the bandgap Vref signal is ready.

The IC power ready logic circuit 355 includes NAND gates (360A, 360B, 360C) and a NOR gate 365, all coupled together as shown. Each of the NAND gates (360A, 360B, 360C) receives the downward shifted POR_bg signal, indicating if the bandgap Vref is good, at one of its inputs, and an associated Vcc good (Vcc1_Gd, Vcc2_Gd, Vcc3_Gd) at its other input, indicating that its associated supply is good. If and when the bandgap Vref is good (as indicated by the POR_bg signal) and its associated supply is good (as indicated by its Vcc good signal), then the NAND gate (360A, 360B, 360C) for the supply asserts low. Each of the NAND gate outputs (POR_Vcc1, POR_Vcc2, POR_Vcc3) is coupled to an input of the NOR gate 365. Thus, when all of the NAND outputs are asserted (low), the NOR gate 365 asserts high, indicating at its POR_IC output that all of the three power supplies are good.

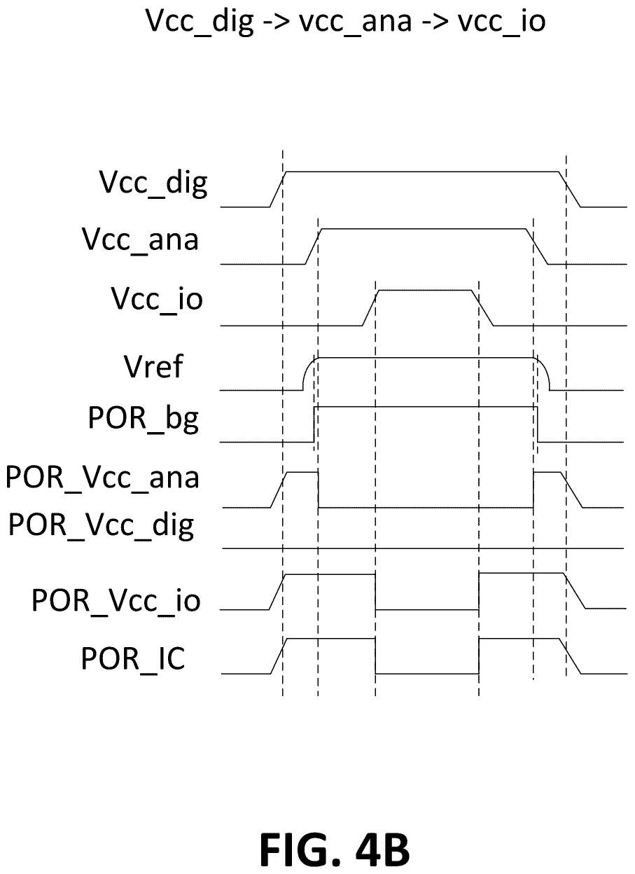

FIG. 4A is a signal diagram illustrating a power-up and power-down sequence for the example POR detection system of FIG. 3 in accordance with some embodiments. It also shows various states of the detection circuits when one or some of the supplies are powered down.

As stated above, FIG. 3 illustrates but one example of a system for detecting supply power-up status for an IC. With that example, an analog supply is used as a master, or primary, supply for bringing up the bandgap circuit, supporting any power-up or power-down sequence. FIG. 4B is a signal diagram showing another power-up and power-down sequence configuration under the same power detector in accordance with some embodiments.

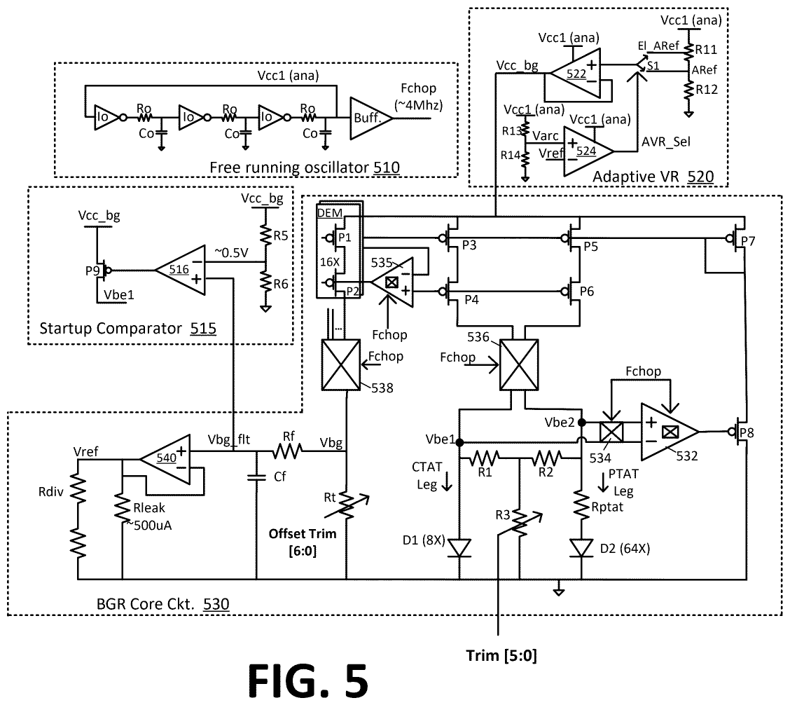

FIG. 5 is a circuit diagram showing a fast start-up bandgap reference circuit in accordance with some embodiments. The bandgap circuit, for example, could be used to implement the bandgap circuits of FIG. 1 (105) or FIG. 3 (305), as well as for any other circuit block or module that may benefit from a bandgap reference circuit, depending upon specific design considerations.

The depicted fast-starting bandgap reference circuit includes an oscillator 510, a start-up comparator 515, an adaptive voltage regulator 520, and a bandgap reference (BGR) core circuit 530, all coupled together as shown.

In the depicted embodiment, the oscillator 510 is a free running oscillator that generates a clock for chopping and dynamic element matching, as will be discussed below. The oscillator includes inverters (Io), resistors (Ro), and capacitors (Co), coupled together in a ring oscillator configuration with a voltage supply Vcc1 that, in this example, is an analog supply for the IC utilizing the bandgap circuit. The oscillator block also includes a buffer amplifier (Buff.) coupled to the ring oscillator to provide a buffered clock (Fchop) generated by the ring oscillator. In some embodiments, the oscillator may use relatively large resistor/capacitor combinations in the inverter stages so that the oscillator is less sensitive to supply ramping. In the depicted embodiment, the oscillator generates the Fchop clock at a frequency around 4 MHZ.

In some embodiments, the free running oscillator may be implemented with a current starved oscillator and the delay may be RC dominant to make it less susceptible to PVT variations. The current may be provided by a constant-gm bias current generator on Vcc1 (ana), which produces current which is independent of voltage. Since the frequency of the oscillator depends on the current, this makes the frequency stable even when the supply is still ramping up.

The start-up comparator circuit 515 includes a comparator 516, threshold ladder resistors R5, R6, and P-type MOS (metal oxide semiconductor) transistor P9, coupled as shown. The circuit works in cooperation with the adaptive reference voltage regulator 520 to enable the bandgap circuit to start up quickly and properly, ramping up as soon as it has enough voltage headroom.

The adaptive reference regulator 520 is formed from a linear regulator 522, an adaptive reference control (ARC) comparator 524, ARC threshold resistor ladder (R13/R14), switch (S1), and an adaptive regulator reference ladder formed from tapped resistor R11 and resistor R12, coupled together as shown.

The adaptive regulator 520 generates at its output a supply voltage (Vcc_bg) for the bandgap circuit off of the Vcc1 supply. The Vec_bg value corresponds to the reference input applied to its non-inverting input, which is selectively coupled to either the nominal adaptive VR reference (Aref) or to an elevated reference (El_ARef) through switch S1, depending on the state of the comparator 524 output (AVR_Sel). A non-inverting input of the comparator 524 is coupled to an ARC reference (Varc), which is defined by the resistors R13, R14, and the level of Vcc1 (ana), which may be assumed to come up fairly quickly. An inverting input of the comparator is coupled to the bandgap output (Vref). So, when the circuit is powered on, the Vref level will be less than the Varc reference, which will cause the comparator output (AVR_Sel) to assert (high) and select the elevated AVR reference (El_ARef) for the voltage regulator 522 input. For example, in some embodiments, the El_ARef voltage may be 200 mV above that of the Aref voltage. This causes the bandgap supply (Vcc_bg) to quickly rise when the circuit is powered on. However, once the bandgap Vref comes up to a sufficiently high level (higher than Varc, the comparator output de-asserts, selecting the nominal VR reference (Aref) from switch S1 for steady-state operation.

The start-up comparator circuit 515 operates to pull up the bandgap Vref level quickly in cooperation with the rising of the accelerated Vcc_bg supply. Since Vcc_bg comes up faster than the Vbg node (discussed further below), which defines the bandgap output (Vref), comparator 516 initially outputs a low, which turns on P9, which in turn pulls the Vbe1 node (discussed below) up to Vcc_bg. This, in turn, causes the bandgap core circuit 530 to drive the bandgap output (Vref) up quickly until the Vbg level is high enough to cause start-up comparator 516 to turn off start-up switch P9 and allow the bandgap core to take independent, steady-state control of the Vbg voltage level.

The bandgap core circuit 530 is implemented with a current mode PTAT/CTAT bandgap circuit configuration that includes ratioed CTAT, PTAT diode pair legs using diodes D1, D2, respectively, and associated resistors R1, R2, R3, and Rptat. The core also includes a chopped bias current mirror circuit that includes dynamic element matched (DEM) mirrored transistors P1, P2, static mirrored (and chopped) transistors P3-P7, amplifier 535, BGR leg chopping circuit 536, DEM chopping circuit 538, and chopped error amplifier 532 with input chopping circuit 534 and output transistor P8, which functions as a source follower to drop the output common mode of error amplifier 532 to a reasonable voltage level. The core 530 also includes a Vref output amplifier circuit formed from amplifier 540, resistors Rdiv, Rleak, a low-pass filter formed from capacitor Cf and resistor Rf and an offset trim resistor Rt, coupled together as shown.

In some embodiments, the chopping error amplifier 532 includes its own chopping functionality to cancel offset, and the input chopping circuit 534 may also be used to couple the CTAT, PTAT leg outputs (Vbe1, Vbe2) to the error amplifier 532 inputs to average out mismatches between the CTAT/PTAT bandgap leg paths. That is, the currents between P3/P4 and P5/P6 are switched using the chopping clocks so that both currents are averaged out to be the same, reducing the current mismatch between P3/P4 and P5/P6.

Along these lines, the BGR current leg chopping circuit 536 functions to switch between current mirrored paths (P3/P4 and P5/P6), which feed the CTAT/PTAT bandgap current legs to balance inaccuracies between these paths. The current between P3/P4 and P5/P6 are switched using the chopping clocks so that both currents are averaged out to be the same, reducing the current mismatch between P3/P4 and P5/P6.

The chopping circuit 538 functions to average the mirrored currents from the multiple DEM mirror legs (P1, P2). It may be implemented with any suitable circuit such as switch circuitry (e.g., multiplexer) controlled by multiple different phases of the Fchop clock. For example, with 16 DEM current legs, combinational logic could be used to cyclically rotate through the 16 different current legs on a balanced cadence so as to effectively average their individual currents and minimize errors resulting from transistor mismatch. Amplifier 535 is a gain boosted cascode amplifier and is used to further boost the Rout of the current mirror P1.

In operation, using dynamic element matching on the multiple output bias current-mirror legs averages out the variations that could otherwise occur, for example, if a single output leg were used. In addition, both DEM mirror device and static mirror device sizing can reduce random variations. Although, to achieve the same reduction while maintaining the same bias current, the static mirror transistors would need to increase on both stacks. So, in some embodiments, DEM may be employed to avoid the need for huge device stacks (e.g., 100+).

The output of the DEM chopping circuit (from the averaged DEM mirrored paths) is fed into a bandgap voltage node (Vbg) at an input filter (Rf/Cf) to generate an input voltage Vbg at an input (Vbg_flt) of the Vref output amplifier 540. The low-pass RC filter (formed from Rf, Cf) at the output stage filters out the static or low frequency mismatches and variations being modulated and reshaped to high frequencies by the chopping circuits including the DEM chopping to achieve overall low pre-trim variations.

The chopping circuits operate to switch two or more inputs across one or more outputs using a clock (Fchop in this example). In the depicted embodiment, the bandgap current leg and difference amplifier input chopping circuits (536, 534) respectively are 2:2 chopping circuits that provide first and second output signals that are switched versions of first and second input signals, switched at a clock frequency as defined by the free-running oscillator clock (Fchop). On the other hand, the DEM chopping circuit 538, as discussed above, switches across 16 input signals to generate a single output that is fed into the output driver 540.

From here, the output driver 540 provides the bandgap reference voltage (Vref) based on the generated internal bandgap voltage (Vbg). In some embodiments, the start-up bandgap circuit is able to generate a valid Vref signal, e.g., 0.8 V BGR voltage without any trimming in around 200 uS and within an accuracy of around 2%. Once the IC has been powered on, this accuracy may be further improved (e.g., to 0.5% or better) using trim resistors Rt, R3.

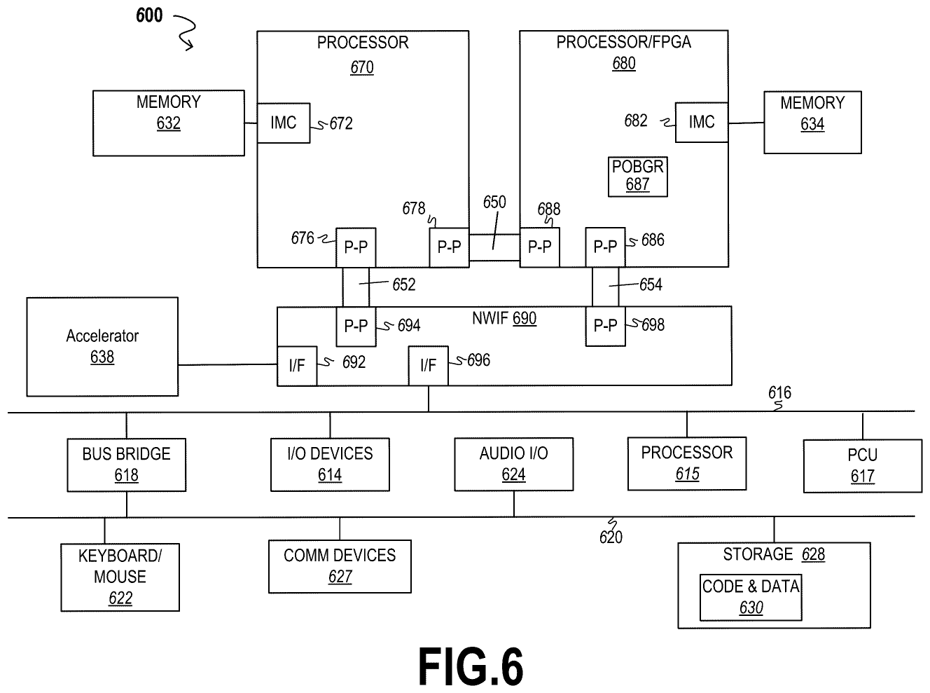

FIG. 6 illustrates an example computing system with a bandgap circuit in accordance with some embodiments. Multiprocessor system 600 is an interfaced system and includes a plurality of processors including a first processor 670 and a second processor 680 coupled via an interface 650 such as a point-to-point (P-P) interconnect, a fabric, and/or bus. In some examples, the first processor 670 and the second processor 680 are homogeneous. In some examples, first processor 670 and the second processor 680 are heterogenous. Though the example system 600 is shown to have two processors, the system may have three or more processors, or may be a single processor system. In some examples, the computing system is implemented, wholly or partially, with a system on a chip (SoC) or a multi-chip (or multi-chiplet) module, in the same or in different package combinations.

Processors 670 and 680 are shown including integrated memory controller (IMC) circuitry 672 and 682, respectively. Processor 670 also includes interface circuits 676 and 678, along with core sets. Similarly, second processor 680 includes interface circuits 686 and 688, along with a core set as well. The second processor, which may be any suitable processor such as an FPGA, also includes a power-on bandgap reference circuit 687, as disclosed herein. A core set generally refers to one or more compute cores that may or may not be grouped into different clusters, hierarchal groups, or groups of common core types. Cores may be configured differently for performing different functions and/or instructions at different performance and/or power levels. The processors may also include other blocks such as memory and other processing unit engines.

Processors 670, 680 may exchange information via the interface 650 using interface circuits 678, 688. IMCs 672 and 682 couple the processors 670, 680 to respective memories, namely a memory 632 and a memory 634, which may be portions of main memory locally attached to the respective processors.

Processors 670, 680 may each exchange information with a network interface (NW I/F) 690 via individual interfaces 652, 654 using interface circuits 676, 694, 686, 698. The network interface 690 (e.g., one or more of an interconnect, bus, and/or fabric, and in some examples is a chipset) may optionally exchange information with a coprocessor 638 via an interface circuit 692. In some examples, the coprocessor 638 is a special-purpose processor, such as, for example, a high-throughput processor, a network or communication processor, compression engine, graphics processor, general purpose graphics processing unit (GPGPU), neural-network processing unit (NPU), embedded processor, or the like.

A shared cache (not shown) may be included in either processor 670, 680 or outside of both processors, yet connected with the processors via an interface such as P-P interconnect, such that either or both processors' local cache information may be stored in the shared cache if a processor is placed into a low power mode.

Network interface 690 may be coupled to a first interface 616 via interface circuit 696. In some examples, first interface 616 may be an interface such as a Peripheral Component Interconnect (PCI) interconnect, a PCI Express interconnect, or another I/O interconnect. In some examples, first interface 616 is coupled to a power control unit (PCU) 617, which may include circuitry, software, and/or firmware to perform power management operations with regard to the processors 670, 680 and/or co-processor 638. PCU 617 provides control information to one or more voltage regulators (not shown) to cause the voltage regulator(s) to generate the appropriate regulated voltage(s). PCU 617 also provides control information to control the operating voltage generated. In various examples, PCU 617 may include a variety of power management logic units (circuitry) to perform hardware-based power management. Such power management may be wholly processor controlled (e.g., by various processor hardware, and which may be triggered by workload and/or power, thermal or other processor constraints) and/or the power management may be performed responsive to external sources (such as a platform or power management source or system software).

PCU 617 is illustrated as being present as logic separate from the processor 670 and/or processor 680. In other cases, PCU 617 may execute on a given one or more of cores (not shown) of processor 670 or 680. In some cases, PCU 617 may be implemented as a microcontroller (dedicated or general-purpose) or other control logic configured to execute its own dedicated power management code, sometimes referred to as P-code. In yet other examples, power management operations to be performed by PCU 617 may be implemented externally to a processor, such as by way of a separate power management integrated circuit (PMIC) or another component external to the processor. In yet other examples, power management operations to be performed by PCU 617 may be implemented within BIOS or other system software. Along these lines, power management may be performed in concert with other power control units implemented autonomously or semi-autonomously, e.g., as controllers or executing software in cores, clusters, IP blocks and/or in other parts of the overall system.

Various I/O devices 614 may be coupled to first interface 616, along with a bus bridge 618 which couples first interface 616 to a second interface 620. In some examples, one or more additional processor(s) 615, such as coprocessors, high throughput many integrated core (MIC) processors, GPGPUs, accelerators (such as graphics accelerators or digital signal processing (DSP) units), field programmable gate arrays (FPGAs), or any other processor, are coupled to first interface 616. In some examples, second interface 620 may be a low pin count (LPC) interface. Various devices may be coupled to second interface 620 including, for example, a keyboard and/or mouse 622, communication devices 627 and storage circuitry 628. Storage circuitry 628 may be one or more non-transitory machine-readable storage media as described below, such as a disk drive or other mass storage device which may include instructions/code and data 630 and may implement the storage in some examples. Further, an audio I/O 624 may be coupled to second interface 620. Note that other architectures than the point-to-point architecture described above are possible. For example, instead of the point-to-point architecture, a system such as multiprocessor system 600 may implement a multi-drop interface or other such architecture.

Processor cores may be implemented in different ways, for different purposes, and in different processors. For instance, implementations of such cores may include: 1) a general purpose in-order core intended for general-purpose computing; 2) a high-performance general purpose out-of-order core intended for general-purpose computing; 3) a special purpose core intended primarily for graphics and/or scientific (throughput) computing. Implementations of different processors may include: 1) a CPU including one or more general purpose in-order cores intended for general-purpose computing and/or one or more general purpose out-of-order cores intended for general-purpose computing; and 2) a coprocessor including one or more special purpose cores intended primarily for graphics and/or scientific (throughput) computing. Such different processors lead to different computer system architectures, which may include: 1) the coprocessor on a separate chip from the CPU; 2) the coprocessor on a separate die in the same package as a CPU; 3) the coprocessor on the same die as a CPU (in which case, such a coprocessor is sometimes referred to as special purpose logic, such as integrated graphics and/or scientific (throughput) logic, or as special purpose cores); and 4) a system on a chip (SoC) that may be included on the same die as the described CPU (sometimes referred to as the application core(s) or application processor(s)), the above described coprocessor, and additional functionality. Example core architectures are described next, followed by descriptions of example processors and computer architectures.

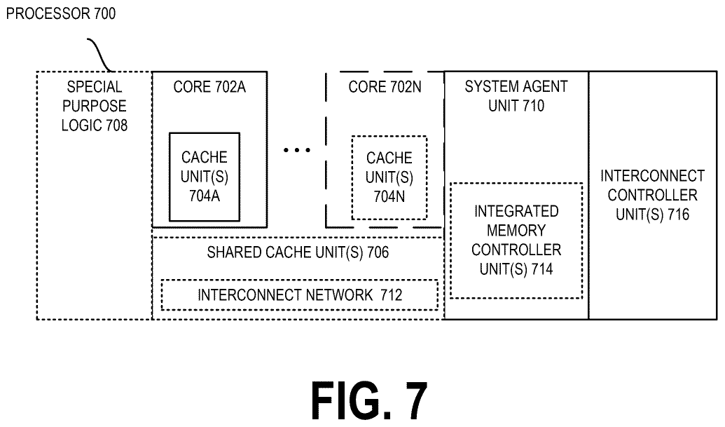

FIG. 7 illustrates a block diagram of an example processor that may have one or more cores and an integrated memory controller in accordance with some embodiments. The solid lined boxes illustrate a processor and/or SoC 700 with a single core 702(A), system agent unit circuitry 710, and a set of one or more interface controller unit(s) circuitry 716, while the optional addition of the dashed lined boxes illustrates an alternative processor and/or SoC 700 with multiple cores 702(A)-(N), a set of one or more integrated memory controller unit(s) circuitry 714 in the system agent unit circuitry 710, and special purpose logic 708, as well as a set of one or more interface controller unit(s) circuitry 716. Note that the processor and/or SoC 700 may be one of the processors 670 or 680, or co-processor 638 or 615 of FIG. 6.

Thus, different implementations of the processor and/or SoC 700 may include: 1) a CPU with the special purpose logic 708 being a high-throughput processor, a network or communication processor, a compression engine, a graphics processor, a general purpose graphics processing unit (GPGPU), a neural-network processing unit (NPU), an embedded processor, a security processor, a matrix accelerator, an in-memory analytics accelerator, a compression accelerator, a data streaming accelerator, data graph operations, or the like (which may include one or more cores, not shown), and the cores 702(A)-(N) being one or more general purpose cores (e.g., general purpose in-order cores, general purpose out-of-order cores, or a combination of the two); 2) a co-processor with the cores 702(A)-(N) being a large number of special purpose cores intended primarily for graphics and/or scientific (throughput); and 3) a co-processor with the cores 702(A)-(N) being a large number of general purpose in-order cores. Thus, the processor and/or SoC 700 may be a general-purpose processor, co-processor or special-purpose processor, such as, for example, a network or communication processor, compression engine, graphics processor, GPGPU (general purpose graphics processing unit), a high throughput many integrated core (MIC) co-processor (including 30 or more cores), embedded processor, or the like. The processor may be implemented on one or more chips. The processor and/or SoC 700 may be a part of and/or may be implemented on one or more substrates using any of a number of process technologies, such as, for example, complementary metal oxide semiconductor (CMOS), bipolar CMOS (BiCMOS), P-type metal oxide semiconductor (PMOS), or N-type metal oxide semiconductor (NMOS).

A memory hierarchy includes one or more levels of cache unit(s) circuitry 704(A)-(N) within the cores 702(A)-(N), a set of one or more shared cache unit(s) circuitry 706, and external memory (not shown) coupled to the set of integrated memory controller unit(s) circuitry 714. The set of one or more shared cache unit(s) circuitry 706 may include one or more mid-level caches, such as level 2 (L2), level 3 (L3), level 4 (L4), or other levels of cache, such as a last level cache (LLC), and/or combinations thereof. While in some examples interface network circuitry 712 (e.g., a ring interconnect) interfaces the special purpose logic 708 (e.g., integrated graphics logic), the set of shared cache unit(s) circuitry 706, and the system agent unit circuitry 710, alternative examples use any number of well-known techniques for interfacing such units. In some examples, coherency is maintained between one or more of the shared cache unit(s) circuitry 706 and cores 702(A)-(N). In some examples, interface controller unit(s) circuitry 716 couple the cores 702(A)-(N) to one or more other devices 718 such as one or more I/O devices, storage, one or more communication devices (e.g., wireless networking, wired networking, etc.), etc.

In some examples, one or more of the cores 702(A)-(N) are capable of multi-threading. The system agent unit circuitry 710 includes those components coordinating and operating cores 702(A)-(N). The system agent unit circuitry 710 may include, for example, power control unit (PCU) circuitry and/or display unit circuitry (not shown). The PCU may be or may include logic and components needed for regulating the power state of the cores 702(A)-(N) and/or the special circuitry is for driving one or more externally connected displays. purpose logic 708 (e.g., integrated graphics logic). The display unit

The cores 702(A)-(N) may be homogenous in terms of instruction set architecture (ISA). Alternatively, the cores 702(A)-(N) may be heterogeneous in terms of ISA; that is, a subset of the cores 702(A)-(N) may be capable of executing an ISA, while other cores may be capable of executing only a subset of that ISA or another ISA.

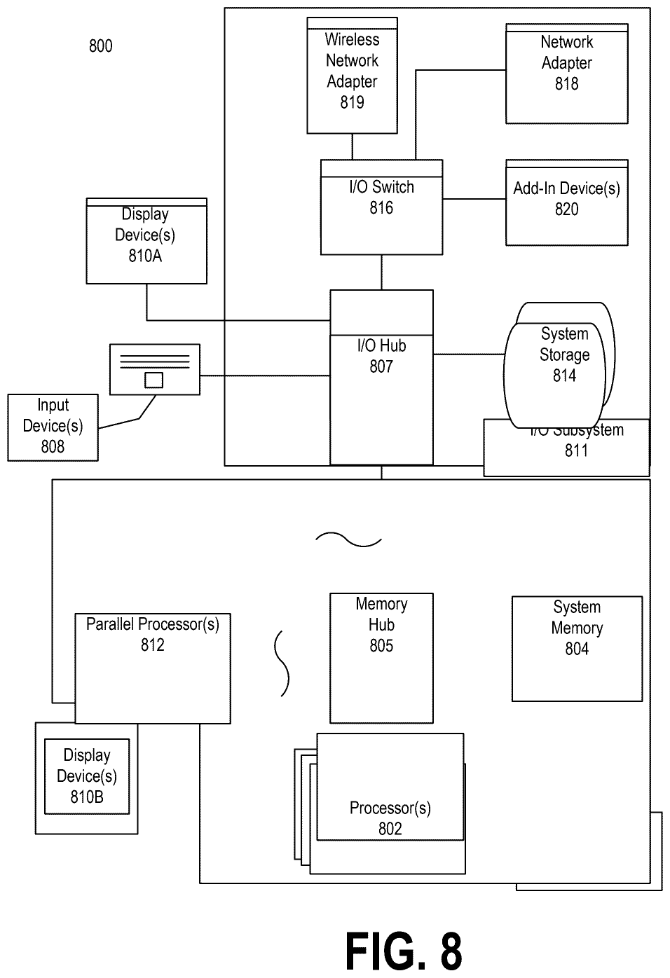

FIG. 8 is a block diagram illustrating a parallel processing computing system 800 configured to implement one or more aspects of the examples described herein. The computing system 800 includes a processing subsystem having one or more processor(s) 802 and a system memory 804 communicating via an interconnection path that may include a memory hub 805. The memory hub 805 may be a separate component within a chipset component or may be integrated within the one or more processor(s) 802. The memory hub 805 couples with an I/O subsystem 811 via a communication link. The I/O subsystem 811 includes an I/O hub 807 that can enable the computing system 800 to receive input from one or more input device(s) 808. Additionally, the I/O hub 807 can enable a display controller, which may be included in the one or more processor(s) 802, to provide outputs to one or more display device(s) 810A. In some examples the one or more display device(s) 810A coupled with the I/O hub 807 can include a local, internal, or embedded display device.

The processing subsystem 801, for example, includes one or more parallel processor(s) 812 coupled to memory hub 805 via a bus or communication link. The communication link 813 may be one of any number of standards-based communication link technologies or protocols, such as, but not limited to PCI Express, or may be a vendor specific communications interface or communications fabric. The one or more parallel processor(s) 812 may form a computationally focused parallel or vector processing system that can include a large number of processing cores and/or processing clusters, such as a many integrated core (MIC) processor. For example, the one or more parallel processor(s) 812 form a graphics processing subsystem that can output pixels to one of the one or more display device(s) 810A coupled via the I/O hub 807. The one or more parallel processor(s) 812 can also include a display controller and display interface (not shown) to enable a direct connection to one or more display device(s) 810B.

Within the I/O subsystem 811, a system storage unit 814 can connect to the I/O hub 807 to provide a storage mechanism for the computing system 800. An I/O switch 816 can be used to provide an interface mechanism to enable connections between the I/O hub 807 and other components, such as a network adapter 818 and/or wireless network adapter 819 that may be integrated into the platform, and various other devices that can be added via one or more add-in device(s) 820. The add-in device(s) 820 may also include, for example, one or more external graphics processor devices, graphics cards, and/or compute accelerators. The network adapter 818 can be an Ethernet adapter or another wired network adapter. The wireless network adapter 819 can include one or more of a Wi-Fi, Bluetooth, near field communication (NFC), or other network device that includes one or more wireless radios.

The computing system 800 can include other components not explicitly shown, including USB or other port connections, optical storage drives, video capture devices, and the like, which may also be connected to the I/O hub 807. Communication paths interconnecting the various components in FIG. 8 may be implemented using any suitable protocols, such as PCI (Peripheral Component Interconnect) based protocols (e.g., PCI-Express), or any other bus or point-to-point communication interfaces and/or protocol(s), such as the NVLink high-speed interconnect, Compute Express Link™ (CXL™) (e.g., CXL.mem), Infinity Fabric (IF), Ethernet (IEEE 802.3), remote direct memory access (RDMA), InfiniBand, Internet Wide Arca RDMA Protocol (iWARP), Transmission Control Protocol (TCP), User Datagram Protocol (UDP), quick UDP Internet Connections (QUIC), RDMA over Converged Ethernet (ROCE), Intel QuickPath Interconnect (QPI), Intel Ultra Path Interconnect (UPI), Intel On-Chip System Fabric (IOSF), Omnipath, HyperTransport, Advanced Microcontroller Bus Architecture (AMBA) interconnect, OpenCAPI, Gen-Z, Cache Coherent Interconnect for Accelerators (CCIX), 3GPP Long Term Evolution (LTE) (4G), 3GPP 5G, and variations thereof, or wired or wireless interconnect protocols known in the art. In some examples, data can be copied or stored to virtualized storage nodes using a protocol such as non-volatile memory express (NVMe) over Fabrics (NVMe-oF) or NVMe.

The one or more parallel processor(s) 812 may incorporate circuitry optimized for graphics and video processing, including, for example, video output circuitry, and constitutes a graphics processing unit (GPU). Alternatively or additionally, the one or more parallel processor(s) 812 can incorporate circuitry optimized for general purpose processing, while preserving the underlying computational architecture, described in greater detail herein. Components of the computing system 800 may be integrated with one or more other system elements on a single integrated circuit. For example, the one or more parallel processor(s) 812, memory hub 805, processor(s) 802, and I/O hub 807 can be integrated into a system on chip (SoC) integrated circuit. Alternatively, the components of the computing system 800 can be integrated into a single package to form a system in package (SIP) configuration. In some examples at least a portion of the components of the computing system 800 can be integrated into a multi-chip module (MCM), which can be interconnected with other multi-chip modules into a modular computing system.

It will be appreciated that the computing system 800 shown herein is illustrative and that variations and modifications are possible. The connection topology, including the number and arrangement of bridges, the number of processor(s) 802, and the number of parallel processor(s) 812, may be modified as desired. For instance, system memory 804 can be connected to the processor(s) 802 directly rather than through a bridge, while other devices communicate with system memory 804 via the memory hub 805 and the processor(s) 802. In other alternative topologies, the parallel processor(s) 812 are connected to the I/O hub 807 or directly to one of the one or more processor(s) 802, rather than to the memory hub 805. In other examples, the I/O hub 807 and memory hub 805 may be integrated into a single chip. It is also possible that two or more sets of processor(s) 802 are attached via multiple sockets, which can couple with two or more instances of the parallel processor(s) 812.

Some of the particular components shown herein are optional and may not be included in all implementations of the computing system 800. For example, any number of add-in cards or peripherals may be supported, or some components may be eliminated. Furthermore, some architectures may use different terminology for components similar to those illustrated in FIG. 8.

For example, the memory hub 805 may be referred to as a Northbridge in some architectures, while the I/O hub 807 may be referred to as a Southbridge.

Illustrative examples of the technologies disclosed herein are provided below. An embodiment of the technologies may include any one or more, and any compatible combination of, the examples described below.

Example 1 is an apparatus that includes a bandgap core circuit, an adaptive voltage regulator and a switch. The bandgap core circuit has a bandgap supply node to receive a bandgap supply voltage. The bandgap core circuit includes first and second bandgap current legs coupled to a difference amplifier, and the bandgap core circuit is to generate a bandgap reference voltage. The adaptive voltage regulator (AVR) is coupled to the bandgap supply node to provide the bandgap supply voltage based on a regulator input voltage at a regulator input node of the adaptive voltage regulator. The switch is coupled to the regulator input node to provide a selected one of a first AVR reference voltage and a second AVR reference voltage that is larger than the first AVR reference voltage.

Example 2 includes the subject matter of example 1, and including a first comparator coupled to the switch to select either the first or second AVR reference voltage based on a level of the bandgap reference voltage.

Example 3 includes the subject matter of any of examples 1-2, and comprising a start-up comparator coupled to the bandgap core circuit to drive the difference amplifier until a bandgap voltage corresponding to the bandgap reference voltage reaches a threshold level.

Example 4 includes the subject matter of any of examples 1-3, and wherein the difference amplifier is a chopping amplifier.

Example 5 includes the subject matter of any of examples 1-4, and including a first chopping circuit coupled between the first and second bandgap legs and input nodes of the difference amplifier.

Example 6 includes the subject matter of any of examples 1-5, and comprising a current mirror circuit coupled to the difference amplifier, the current mirror circuit including first and second current mirror legs coupled to the first and second bandgap legs through a second chopping circuit.

Example 7 includes the subject matter of any of examples 1-6, and comprising a current mirror circuit coupled to the difference amplifier, the current mirror circuit including a dynamic element matching (DEM) circuit with a plurality of DEM current legs coupled to a bandgap voltage node through a third chopping circuit.

Example 8 includes the subject matter of any of examples 1-7, and comprising an output amplifier circuit with an output amplifier input coupled to the bandgap voltage node and an output amplifier output node to provide the bandgap reference voltage.

Example 9 includes the subject matter of any of examples 1-8, and comprising a filter coupled between the output amplifier input node and the bandgap voltage node.

Example 10 includes the subject matter of any of examples 1-9, and including an oscillator to provide a chopping clock, the oscillator to be powered from a first integrated circuit (IC) supply.

Example 11 includes the subject matter of any of examples 1-10, and wherein the adaptive voltage regulator is powered off of the first IC supply.

Example 12 is an apparatus that includes first and second bandgap current legs coupled to inputs of a difference amplifier. It also includes a current mirror biasing circuit coupled to an output of the difference amplifier. The current mirror biasing circuit includes first and second current mirror legs coupled to the first and second bandgap current legs through a first chopping circuit. The apparatus further includes an output amplifier coupled to the current mirror biasing circuit at a bandgap voltage node. The output amplifier is to generate a bandgap reference voltage based on a bandgap voltage at the bandgap voltage node.

Example 13 includes the subject matter of example 12, and including a second chopping circuit coupled between the first and second bandgap legs and the inputs of the difference amplifier.

Example 14 includes the subject matter of any of examples 12-13, and wherein the difference amplifier is a chopping amplifier.

Example 15 includes the subject matter of any of examples 12-14, and wherein the current mirror biasing circuit includes a dynamic element matching (DEM) circuit with a plurality of DEM current mirror legs coupled to the bandgap voltage node through a third chopping circuit.

Example 16 includes the subject matter of any of examples 12-15, and comprising a filter coupled between the output amplifier and the bandgap voltage node.

Example 17 includes the subject matter of any of examples 12-16, and including an oscillator to provide a chopping clock, the oscillator to be powered from a first integrated circuit (IC) supply.

Example 18 includes the subject matter of any of examples 12-17, and including: an adaptive voltage regulator (AVR) to provide a bandgap supply voltage to the current mirror biasing circuit and difference amplifier, the bandgap supply voltage being based on a regulator input voltage at a regulator input node of the adaptive voltage regulator, and a switch coupled to the regulator input node to provide a selected one of a first AVR reference voltage and a second AVR reference voltage that is larger than the first AVR reference voltage.

Example 19 includes the subject matter of any of examples 12-18, and including a first comparator coupled to the switch to select either the first or second AVR reference voltage based on a level of the bandgap reference voltage.

Example 20 includes the subject matter of any of examples 12-19, and comprising a start-up comparator coupled to the difference amplifier to drive it until the bandgap voltage reaches a threshold level.

Example 21 includes the subject matter of any of examples 12-20, and wherein the adaptive voltage regulator is powered off of the first IC supply.

Example 22 is an integrated circuit (IC) apparatus that includes a bandgap circuit and a power-on detection circuit. The bandgap circuit is to generate a bandgap reference voltage off of a first IC supply voltage. The power-on detection circuit is to detect the first IC supply voltage being ready based on the bandgap reference voltage. The bandgap circuit includes first and second bandgap current legs coupled to inputs of a difference amplifier, a current mirror biasing circuit coupled to an output of the difference amplifier. The current mirror biasing circuit includes first and second current mirror legs coupled to the first and second bandgap current legs through a first chopping circuit. The bandgap circuit also includes an output amplifier coupled to the current mirror biasing circuit at a bandgap voltage node. The output amplifier is to generate the bandgap reference voltage based on a bandgap voltage at the bandgap voltage node.

Example 23 includes the subject matter of example 22, and including a second chopping circuit coupled between the first and second bandgap legs and the inputs of the difference amplifier.

Example 24 includes the subject matter of any of examples 22-23, and wherein the difference amplifier is a chopping amplifier.

Example 25 includes the subject matter of any of examples 22-24, and wherein the current mirror biasing circuit includes a dynamic element matching (DEM) circuit with a plurality of DEM current mirror legs coupled to the bandgap voltage node through a third chopping circuit.

Example 26 includes the subject matter of any of examples 22-25, and comprising a filter coupled between the output amplifier and the bandgap voltage node.

Example 27 includes the subject matter of any of examples 22-26, and including an oscillator to provide a chopping clock, the oscillator to be powered from a first integrated circuit (IC) supply.

Example 28 includes the subject matter of any of examples 22-27, and including an adaptive voltage regulator (AVR) to provide a bandgap supply voltage to the current mirror biasing circuit and difference amplifier. The bandgap supply voltage being based on a regulator input voltage at a regulator input node of the adaptive voltage regulator. The bandgap circuit also includes a switch coupled to the regulator input node to provide a selected one of a first AVR reference voltage and a second AVR reference voltage that is larger than the first AVR reference voltage.

Example 29 includes the subject matter of any of examples 22-28, and including a first comparator coupled to the switch to select either the first or second AVR reference voltage based on a level of the bandgap reference voltage.

Example 30 includes the subject matter of any of examples 22-29, and comprising a start-up comparator coupled to the difference amplifier to drive it until the bandgap voltage reaches a threshold level.

Example 31 includes the subject matter of any of examples 22-30, and wherein the adaptive voltage regulator is powered off of the first IC supply.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included.

Throughout the specification, and in the claims, the term “connected” means a direct connection, such as electrical, mechanical, or magnetic connection between the things that are connected, without any intermediary devices.

The term “coupled” means a direct or indirect connection, such as a direct electrical, mechanical, or magnetic connection between the things that are connected or an indirect connection, through one or more passive or active intermediary devices.

The term “circuit” or “module” may refer to one or more passive and/or active components that are arranged to cooperate with one another to provide a desired function. It should be appreciated that different circuits or modules may consist of separate components, they may include both distinct and shared components, or they may consist of the same components. For example, A controller circuit may be a first circuit for performing a first function, and at the same time, it may be a second controller circuit for performing a second function, related or not related to the first function.

The meaning of “in” includes “in” and “on” unless expressly distinguished for a specific description.

The terms “substantially,” “close,” “approximately,” “near,” and “about,” unless otherwise indicated, generally refer to being within +/−10% of a target value.

Unless otherwise specified, the use of the ordinal adjectives “first,” “second,” and “third,” etc., to describe a common object, merely indicate that different instances of like objects are being referred to and are not intended to imply that the objects so described must be in a given sequence, either temporally, spatially, in ranking or in any other manner

For the purposes of the present disclosure, phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

It is pointed out that those elements of the figures having the same reference numbers (or names) as the elements of any other figure can operate or function in any manner similar to that described but are not limited to such.

For purposes of the embodiments, unless expressly described differently, the transistors in various circuits and logic blocks described herein may be implemented with any suitable transistor type such as field effect transistors (FETs) or bipolar type transistors. FET transistor types may include but are not limited to metal oxide semiconductor (MOS) type FETs such as tri-gate, FinFET, and gate all around (GAA) FET transistors, as well as tunneling FET (TFET) transistors, ferroelectric FET (FeFET) transistors.

In the drawings of the embodiments, signals are represented with lines. Some lines may appear different from others, for example, thicker or hatched, to distinguish from other depicted signals for case of understanding. Along these lines, some signal lines may have arrows at one or more ends, to indicate a primary direction of information flow. However, such indications are not intended to be limiting. Rather, lines are used in connection with one or more exemplary embodiments in a given figure to facilitate easier understanding of concepts embodied in block, circuit, and/or flow diagrams. Any represented signal, as dictated by design needs or preferences, may actually comprise one or more signals that may travel in either direction and may be implemented with any suitable type of signal scheme, e.g., analog, digital, wired, wireless, upon the platform within which the present disclosure is to be implemented.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. Memory elements, as described herein, are examples of a computer readable storage medium.

As defined herein, the term “processor” means at least one hardware circuit configured to carry out instructions contained in program code. The hardware circuit may be implemented with one or more integrated circuits. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, a graphics processing unit (GPU), a controller, and so forth. It should be appreciated that a logical processor, on the other hand, is a processing abstraction associated with a core, for example when one or more SMT cores are being used such that multiple logical processors may be associated with a given core, for example, in the context of core thread assignment.

It should be appreciated that a processor or processor system may be implemented in various different manners. For example, they may be implemented on a single die, multiple dies (dielets, chiplets), one or more dies in a common package, or one or more dies in multiple packages. Along these lines, some of these blocks may be located separately on different dies or together on two or more different dies.

While the flow diagrams in the figures show a particular order of operations performed by certain embodiments of the invention, it should be understood that such order is exemplary (e.g., alternative embodiments may perform the operations in a different order, combine certain operations, overlap certain operations, etc.).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. An apparatus, comprising:
first and second bandgap current legs coupled to inputs of a difference amplifier;
a current mirror biasing circuit coupled to an output of the difference amplifier, the current mirror biasing circuit including first and second current mirror legs coupled to the first and second bandgap current legs through a first chopping circuit; and
an output amplifier coupled to the current mirror biasing circuit at a bandgap voltage node, the output amplifier to generate a bandgap reference voltage based on a bandgap voltage at the bandgap voltage node.

2. The apparatus of claim 1, including a second chopping circuit coupled between the first and second bandgap legs and the inputs of the difference amplifier.

3. The apparatus of claim 1, wherein the difference amplifier is a chopping amplifier.

4. The apparatus of claim 1, wherein the current mirror biasing circuit includes a dynamic element matching (DEM) circuit with a plurality of DEM current mirror legs coupled to the bandgap voltage node through a third chopping circuit.

5. The apparatus of claim 1, comprising a filter coupled between the output amplifier and the bandgap voltage node.

6. The apparatus of claim 1, including an oscillator to provide a chopping clock, the oscillator to be powered from a first integrated circuit (IC) supply.

7. The apparatus of claim 6, including:
an adaptive voltage regulator (AVR) to provide a bandgap supply voltage to the current mirror biasing circuit and difference amplifier, the bandgap supply voltage being based on a regulator input voltage at a regulator input node of the adaptive voltage regulator, and
a switch coupled to the regulator input node to provide a selected one of a first AVR reference voltage and a second AVR reference voltage that is larger than the first AVR reference voltage.

8. The apparatus of claim 7, including a first comparator coupled to the switch to select either the first or second AVR reference voltage based on a level of the bandgap reference voltage.

9. The apparatus of claim 8, comprising a start-up comparator coupled to the difference amplifier to drive it until the bandgap voltage reaches a threshold level.

10. The apparatus of claim 9, wherein the adaptive voltage regulator is powered off of the first IC supply.

11. An apparatus, comprising:
a bandgap core circuit with a bandgap supply node to receive a bandgap supply voltage, the bandgap core circuit including first and second bandgap current legs coupled to a difference amplifier, the bandgap core circuit to generate a bandgap reference voltage;
an adaptive voltage regulator (AVR) coupled to the bandgap supply node to provide the bandgap supply voltage based on a regulator input voltage at a regulator input node of the adaptive voltage regulator; and
a switch coupled to the regulator input node to provide a selected one of a first AVR reference voltage and a second AVR reference voltage that is larger than the first AVR reference voltage.

12. The apparatus of claim 11, including a first comparator coupled to the switch to select either the first or second AVR reference voltage based on a level of the bandgap reference voltage.

13. The apparatus of claim 11, comprising a start-up comparator coupled to the bandgap core circuit to drive the difference amplifier until a bandgap voltage corresponding to the bandgap reference voltage reaches a threshold level.

14. The apparatus of claim 11, wherein the difference amplifier is a chopping amplifier.

15. The apparatus of claim 11, including a first chopping circuit coupled between the first and second bandgap legs and input nodes of the difference amplifier.

16. The apparatus of claim 11, comprising a current mirror circuit coupled to the difference amplifier, the current mirror circuit including first and second current mirror legs coupled to the first and second bandgap legs through a second chopping circuit.

17. The apparatus of claim 11, comprising a current mirror circuit coupled to the difference amplifier, the current mirror circuit including a dynamic element matching (DEM) circuit with a plurality of DEM current legs coupled to a bandgap voltage node through a third chopping circuit.

18. An integrated circuit (IC) apparatus, comprising:
a bandgap circuit to generate a bandgap reference voltage off of a first IC supply voltage; and
a power-on detection circuit to detect the first IC supply voltage being ready based on the bandgap reference voltage;
wherein the bandgap circuit includes:
first and second bandgap current legs coupled to inputs of a difference amplifier;
a current mirror biasing circuit coupled to an output of the difference amplifier, the current mirror biasing circuit including first and second current mirror legs coupled to the first and second bandgap current legs through a first chopping circuit, and
an output amplifier coupled to the current mirror biasing circuit at a bandgap voltage node, the output amplifier to generate the bandgap reference voltage based on a bandgap voltage at the bandgap voltage node.

19. The apparatus of claim 18, including a second chopping circuit coupled between the first and second bandgap legs and the inputs of the difference amplifier.

20. The apparatus of claim 18, wherein the difference amplifier is a chopping amplifier.
